(19) United States
(12) Patent Application Publication
(10) Pub. No.: US 2026/0161850 A1
(43) Pub. Date: Jun. 11, 2026

(54) COMPUTING PERIPHERAL POINTS OF SPOOL COMPONENTS FROM PIPING COMPONENT DATA

(71) Applicant: Hexagon Technology Center GmbH, Heerbrugg (CH)

(72) Inventors: Mohan Kingam, Hyderabad (IN); Bijay Swarnkar, Morang (NP)

(21) Appl. No.: 18/972,145

(22) Filed: Dec. 6, 2024

(51) Int. Cl. G06F 30/23; G06F 113/14; G06T 17/20

(52) U.S. Cl. CPC G06F 30/23; G06T 17/20; G06F 2113/14; G06T 2210/12

(57) ABSTRACT

A system, method, and computer program product computes peripheral points of pipe spool components by performing, for each of a plurality of piping components of a pipe spool, extracting 3D end point coordinates and leg direction of the pipeline component from component attributes in a piping isometrics model or PCF data; deriving two vectors perpendicular to the component's leg direction; computing coordinates of an outer diameter of the piping component perpendicular to the leg direction using center key points and the perpendicular vectors; projecting the coordinates onto vertices of a minimum rectangle that encompasses the piping component; computing minimum and maximum coordinates in X, Y, and Z directions from the computed coordinates for the plurality of pipeline components; and computing a minimum bounding box for the pipe spool based on the minimum and maximum coordinates in the X, Y, and Z directions.

### CROSS-REFERENCE TO RELATED APPLICATION(S)

None.

### FIELD OF THE INVENTION

The invention generally relates to piping systems and, more particularly, to computing peripheral points of spool components from piping data.

### BACKGROUND OF THE INVENTION

Piping designers commonly use Piping Component File (PCF), a generic file format that contains piping data that encompasses the attributes and 3D start and end points of piping components such as pipes, valves, fittings, and instruments, allowing for seamless communication between different piping design applications. PCF is an industry-standard piping format used by EPCs (Engineering, Procurement, and Construction) and fabricators. Piping designers typically use piping fabrication tools to design the pipeline or import the pipeline data (PCF) and generate the pipeline model along with pipe spools. A pipe spool is a section of a piping system that includes such things as pipes, fittings, and flanges. Often, a pipe spool will be prefabricated off-site and delivered to the construction site for installation (e.g., connected with one or more other pipe spools or other piping components). Determining the physical geometry of a spool (sometimes referred to for convenience as a spool bounding box) is critical to some functionalities like spool transportation, optimizing logistics, pre-manufacturing checks, checking spool fit in a container, etc.

### SUMMARY OF VARIOUS EMBODIMENTS

In accordance with certain embodiments of the invention, a system, method, and computer program product computes peripheral points of pipe spool components by performing, for each of a plurality of piping components of a pipe spool, extracting 3D end point coordinates and leg direction of the pipeline component from component attributes in a piping isometrics model or PCF data; deriving two vectors perpendicular to the component's leg direction; computing coordinates of an outer diameter of the piping component perpendicular to the leg direction using center key points and the perpendicular vectors; projecting the coordinates onto vertices of a minimum rectangle that encompasses the piping component; computing minimum and maximum coordinates in X, Y, and Z directions from the computed coordinates for the plurality of pipeline components; and computing a minimum bounding box for the pipe spool based on the minimum and maximum coordinates in the X, Y, and Z directions.

In various alternative embodiments, the bounding box may be computed without generating 3D surface models of the plurality of piping components. Computing the bounding box may involve computing oriented axes for the bounding box based on the minimum and maximum coordinates in the X, Y, and Z directions and computing the length, width, and height of the bounding box with respect to the oriented axes. Projecting the coordinates may involve computing the vectors Vaxis=Vector along the center of the pipe; VaxisP1=First Vector perpendicular to vector along the center of the pipe; −VaxisP1=Opposite to the VaxisP1; VaxisP2=2^{nd} Vector perpendicular to VaxisP1 and Vaxis; and −VaxisP2=Opposite to VaxisP2. The plurality of pipeline components may include at least one component having an irregular shape, in which case computing coordinates of an outer diameter of the piping component comprises converting the irregular shape to unique points in 3D space. Embodiments may further display the bounding box on a computer display for analysis by a user and/or determine if the bounding box fits within a predetermined container.

Additional embodiments may be disclosed and claimed.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a schematic diagram of a system 200 for computing peripheral points of spool components from a PCF file, in accordance with certain embodiments.

FIG. 2 is an example piping isometric model generated in SPOOLGEN from imported PCF data, in accordance with certain embodiments.

FIG. 3 are screenshots showing representations of minimum bounding boxes created around projected 3D points for three example spools, in accordance with certain embodiments.

FIG. 4 is a schematic diagram showing a pipe component center line and projected points on the plane passing through the center points, in accordance with certain embodiments.

FIG. 5 is a schematic diagram showing a valve with flanges in 2D and 3D projected points, in accordance with certain embodiments.

FIG. 6 is a portion of a screenshot showing 3D key points connecting a pipeline segment, in accordance with certain embodiments.

FIG. 7 is a schematic diagram providing an example of projecting 3D key points onto the periphery of a pipe, in accordance with certain embodiments.

FIG. 8 is a schematic diagram providing an example of a minimum bounding box generated from points on a spool periphery, in accordance with certain embodiments.

FIG. 9 is a screenshot showing an example graphical user interface for generating and displaying a bounding box and/or container using the 3D points computed as described herein, in accordance with certain embodiments.

FIG. 10 is a flow chart depicting a process for computing points representing the outer periphery of a spool, in accordance with certain embodiments.

It should be noted that the foregoing figures and the elements depicted therein are not necessarily drawn to consistent scale or to any scale. Unless the context otherwise suggests, like elements are indicated by like numerals. The drawings are primarily for illustrative purposes and are not intended to limit the scope of the inventive subject matter described herein.

### DESCRIPTION OF ILLUSTRATIVE EMBODIMENTS

Embodiments of the present invention compute the 3D peripheral and range points of the boundary extents for the piping components of a piping system or pipe spool (sometimes referred to for convenience as a spool bounding box) from a piping isometric model with center point data or from PCF data that contains the piping component line start and end points along with the bore of the pipe components. The computations are performed using the route direction of the piping component and its nominal diameter by leveraging eigen values, eigen vectors, and linear algebra to evaluate the minimum range of the spool components. Embodiments can extend to any irregular shape (e.g., non-linear objects) by converting them to unique points in 3D space. Since most fabrication designs are line diagrams with coordinates and direction information rather than 3D surface designs, embodiments will allow extraction of the minimum range of the pipe spools and computation of the minimum volume required for logistics without depending on the actual 3D design, thereby reducing the amount of computation resources, memory resources, and person-hours needed to compute the maximum extent of the physical geometry of piping components and a corresponding spool bounding box. Embodiments are domain agnostic, can be utilized by any piping designer/manufacturer to extract information from PCF data, and also can be extended to any industry that needs interference checks to ship the objects through containers.

Thus, embodiments can allow piping isometric designers and fabricators to extract and represent the peripheral geometry of pipe spools in the form of points in 3D space. Without limitation, embodiments can use these 3D points for a wide variety of functionality such as:
To compute the minimum bounding box for pipe spools and predict the container required for a given spool.
To compute and generate bounding box dimensions for multiple objects simultaneously.
To ensure that pipe spools, which are prefabricated sections of piping, fit accurately into containers or designated spaces for transport.
To visualize the bounding box of container and pipe spools in 3D view.
To visualize whether a spool fits in a standard container.
To identify an optimum container for transportation.
To efficiently arrange spools within containers that can contribute to overall logistics optimization, reducing transportation costs and improving the use of available space.
To validate the dimensions and compatibility of components before physical manufacturing, e.g., to aid in the prototyping and design validation process.
To compute manufacturability checks for piping components.
To validate the spool size with the available bending machines on the shop floor and assign the machine accordingly.

It should be noted that certain embodiments may be described herein with reference to the Intergraph SPOOLGEN® piping design tool, which is a proven, industrial-strength application that enables the creation of piping isometric drawings for fabrication and erection from the design created during the detail engineering phase of projects. The technology is based on ISOGEN®, the industry-standard software for automated piping isometric generation and has been deployed successfully on all sizes of plant engineering projects in every region of the world. It is expected that the SPOOLGEN piping design tool will be enhanced with functionality of the type described herein. However, it should be noted that embodiments are not limited to the Intergraph SPOOLGEN® piping design tool or to ISOGEN® software but instead can be implemented with other tools and software.

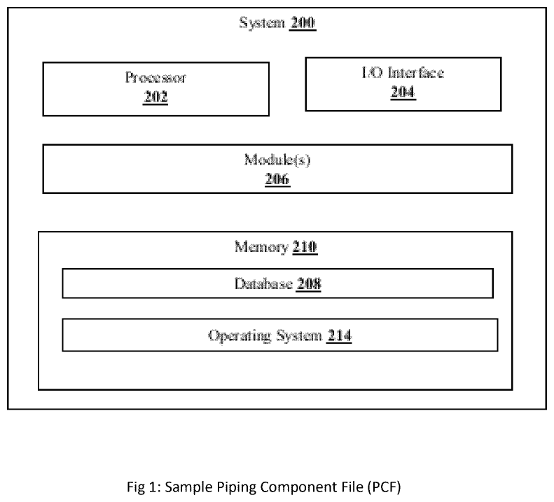

FIG. 1 is a schematic diagram of a system 200 for computing peripheral points of spool components from a PCF file such as by the SPOOLGEN piping design tool or other system, in accordance with certain embodiments. The system 200 may be included within, but is not limited to, one or more devices such as a server, a computer, a personal computing device, a user equipment, a laptop, a tablet, a mobile communication device, and so forth. Further, the system 200 may include one or more processors 202 (hereafter referred to as “the processor 202”), an Input/Output (I/O) interface 204, a plurality of modules 206, a transceiver 208, and a memory 210 communicably to each other. The processor 202 may include one or more cloud-based processors.

The processor 202 may include specialized processing units such as, but not limited to, integrated system (bus) controllers, memory management control units, floating point units, digital signal processing units, etc. In one embodiment, the processor 202 may include a Central Processing Unit (CPU), a Graphics Processing Unit (GPU), or both. The processor 202 may be one or more general processors, Digital Signal Processors (DSPs), Application-Specific Integrated Circuits (ASIC), Field-Programmable Gate Arrays (FPGAs), servers, networks, digital circuits, analog circuits, combinations thereof, or other now known or later developed devices for analyzing and processing data. The processor 202 may execute a software program, such as code generated manually (i.e., programmed) to perform the desired operation.

The processor 202 may be disposed in communication with one or more input/output (I/O) devices via one or more I/O interfaces (hereafter referred to as “the I/O interface 204”). The I/O interface 204 may employ communication techniques such as, Code-Division Multiple Access (CDMA), High-Speed Packet Access (HSPA+), Global System for Mobile communications (GSM), Long-Term Evolution (LTE), WiMax, WiFi, Bluetooth, or the like, etc.

Using the I/O interface 204, the system 200 may communicate with one or more I/O devices. For example, the input device may be an antenna, microphone, touch screen, touchpad, storage device, transceiver, video device/source, etc. The output devices may be a printer, fax machine, video display (e.g., Cathode Ray Tube (CRT), Liquid Crystal Display (LCD), Light-Emitting Diode (LED), Plasma Display Panel (PDP), Organic Light-Emitting Diode display (OLED) or the like), audio speaker, etc.

The processor/controller 202 may be disposed in communication with a communication network via a network interface. In an embodiment, the network interface may be the I/O interface 204. The network interface may connect to the communication network to enable connection of the system 200 with the outside environment and/or device/system. The network interface may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. The communication network may include, without limitation, a direct interconnection, Local Area network (LAN), Wide Area Network (WAN), wireless network (e.g., using Wireless Application Protocol), the internet, etc.

The plurality of modules 206, amongst other things, include routines, programs, objects, components, data structures, etc., which perform particular tasks or implement data types. The plurality of modules 206 may also be implemented as, signal processor(s), state machine(s), logic circuitries, and/or any other device or component that manipulate signals based on operational instructions.

Further, the plurality of modules 206 may be implemented in hardware, instructions executed by at least one processing unit, for e.g., the processor 202, or by a combination thereof. The processing unit may comprise a computer, a processor, a state machine, a logic array and/or any other suitable devices capable of processing instructions. The processing unit may be a general-purpose processor which executes instructions to cause the general-purpose processor to perform operations or, the processing unit may be dedicated to performing the required functions. In some example embodiments, the plurality of modules 206 may be machine-readable instructions (software, such as web-application, mobile application, program, etc.) which, when executed by the processor/processing unit, perform any of the described functionalities.

In an implementation, the plurality of modules 206 may include a receiving module, an identifying module, and a generating module, configured to perform one or more operations of the processor 202. The processor 202 may be communicably coupled to the plurality of the modules 206 to perform the operations, as discussed herein.

In an embodiment of the present disclosure, the plurality of modules 206 may be implemented as part of the processor 202. In another embodiment of the present disclosure, the plurality of modules 206 may be external to the processor 202. In yet another embodiment of the present disclosure, the plurality of modules 206 may be part of the memory 210. In another embodiment of the present disclosure, the plurality of modules 206 may be part of hardware, separate from the processor 202 and/or the memory 210.

The memory 210 may be configured to store data and/or instructions executable by the processor 202. In one embodiment, the memory 210 may communicate via a bus within the system 200. The memory 210 may include any non-transitory computer-readable medium known in the art including, for example, volatile memory, such as Static Random-Access Memory (SRAM) and Dynamic Random-Access Memory (DRAM), and/or non-volatile memory, such as Read-Only Memory (ROM), Erasable Programmable ROM (EPROM), flash memories, hard disks, optical disks, and magnetic tapes. In one example, the memory 210 may include a cache or random-access memory for the processor 202. In alternative examples, the memory 210 is separate from the processor 202, such as a cache memory of a processor, the system memory, or other memory. The memory 210 may be an external storage device or a database 208 for storing data. The functions, acts or tasks illustrated in the figures or described may be performed by the programmed processor 202 by executing the instructions stored in the memory 210. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like. Further, the memory 210 may include an operating system 214 for performing one or more tasks of the system 200, as performed by a generic operating system in the computing domain.

Further, it is contemplated that embodiments may include a tangible, non-transitory computer-readable medium that includes instructions or receives and executes instructions responsive to a propagated signal. Further, the instructions may be transmitted or received over the network via a communication port or interface or using a bus (not shown). The communication port or interface may be a part of the processor 202 or may be a separate component. The communication port may be created in software or may be a physical connection in hardware. The communication port may be configured to connect with a network, external media, the display, or any other components in the system, or combinations thereof. The connection with the network may be a physical connection, such as a wired Ethernet connection or may be established wirelessly. Likewise, the additional connections with other components of the system 200 may be physical or may be established wirelessly. The network may alternatively be directly connected to the bus. For the sake of brevity, the architecture, and standard operations of the processor 202, the one or more modules 206, and the memory 210 are not discussed in detail.

In an embodiment, the processor 202 may be configured to receive and process PCF data such as from a PCF file stored in the memory 210 or obtained via the I/O interface 204. The following is a sample Piping Component File (PCF) presented for the sake of discussion:

FLANGE
SKEY FLWN

| | |
|---|---|
| UNIQUE-COMPONENT-IDENTIFIER | 04ZE-FLNG-64 |

| | | |
|---|---|---|
| END-POINT 56460.6875 62581.3750 | 9534.0645 | 6 |
| END-POINT 56464.1875 62581.3750 | 9534.0645 | 6 |

| | |
|---|---|
| PIPING-SPEC | 04ZE- L-A- L8001 |
| INSULATION-SPEC | L8001 |

FABRICATION-ITEM
TRACING-ON

| | |
|---|---|
| ITEM-CODE | N.A.-001 |

| | | |
|---|---|---|
| SPOOL-IDENTIFIER | 04ZE- | PSP-4 |

FLANGE
SKEY FLWN

| | |
|---|---|
| UNIQUE-COMPONENT-IDENTIFIER | 04ZE-FLNG-68 |

| | | |
|---|---|---|
| END-POINT 56555.4453 62581.3750 | 9534.0654 | 6 |
| END-POINT 56551.9453 62581.3750 | 9534.0654 | 6 |

| | |
|---|---|
| PIPING-SPEC | 04ZE- L-A- L8001 |
| INSULATION-SPEC | L8001 |

FABRICATION-ITEM
TRACING-ON

| | |
|---|---|
| ITEM-CODE | N.A.-001 |

PIPE

| | |
|---|---|
| UNIQUE-COMPONENT-IDENTIFIER | 04ZE-PIPE-169 |

| | | |
|---|---|---|
| END-POINT 56526.0000 62574.7461 | 9381.9375 | 6 |
| END-POINT 56526.0000 62574.7422 | 9523.6826 | 6 |

| | |
|---|---|
| PIPING-SPEC | 04ZE- L-A- L8001 |
| INSULATION-SPEC | L8001 |

FABRICATION-ITEM
TRACING-ON

| | |
|---|---|
| ITEM-CODE | N.A.-002 |

TEE
SKEY TEBW

| UNIQUE-COMPONENT-IDENTIFIER | 04ZE-PIPE-493 | |
|---|---|---|
| BRANCH1-POINT 56526.0000 62577.3984 | 9530.0879 | 6 |
| CENTRE-POINT 56526.0000 62581.3750 | 9534.0654 | |
| END-POINT 56531.6250 62581.3750 | 9534.0654 | 6 |
| END-POINT 56520.3750 62581.3750 | 9534.0654 | 6 |
| PIPING-SPEC | 04ZE- L-A- L8001 | |
| INSULATION-SPEC | L8001 | |
| FABRICATION-ITEM | | |
| TRACING-ON | | |

| | |
|---|---|
| ITEM-CODE | N.A.-003 |

This PCF file defines a piping system or pipe spool including a section of pipe with two flanges and a tee. PCF can be used to represent other types of piping components such as valves, reducers, olets, tees, flanges, penetration plates, supports, tap connections, jackets, spindles, end connections, joints, bends, welds, etc. Complex piping systems and pipe spools can be represented. PCF is a well-known and well-understood technology and therefore it is expected that persons of ordinary skill in the art will understand PCF and its typical uses without further discussion. That being said, an overview of PCF with examples in the context of the SPOOLGEN piping design tool can be found online at https://docs.hexagonppm.com/r/en-US/PCF-Reference-Guide/Version-15/295309.

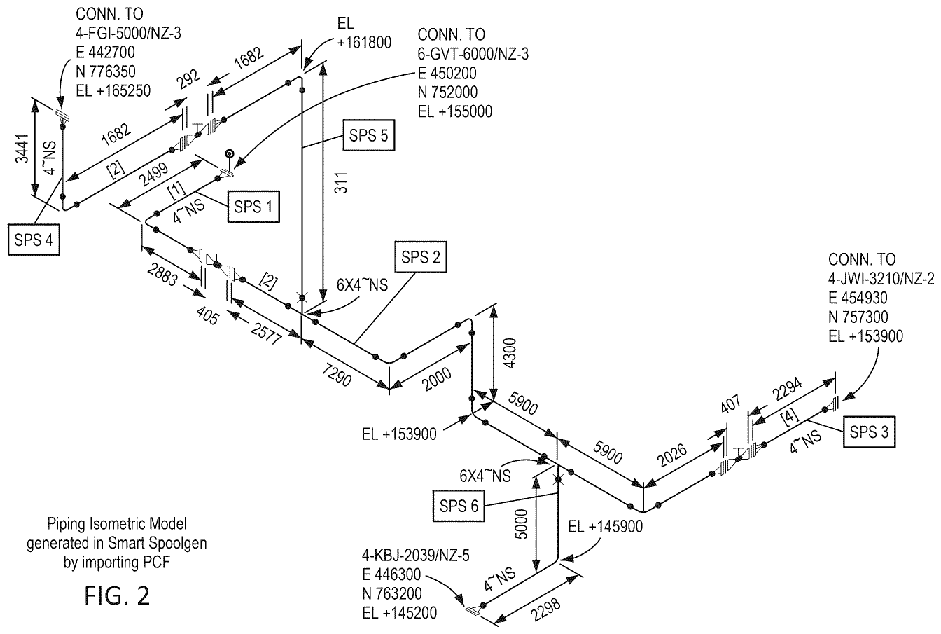

FIG. 2 shows an example piping isometric model generated in the SPOOLGEN tool from imported PCF data, in accordance with certain embodiments. As shown, the piping isometric model includes center lines representing pipes and symbols representing piping components (e.g., valves, reducers, olets, tees, flanges, welds, etc.) respectively oriented in isometric view direction in a 2D editor with associated 3D end point information.

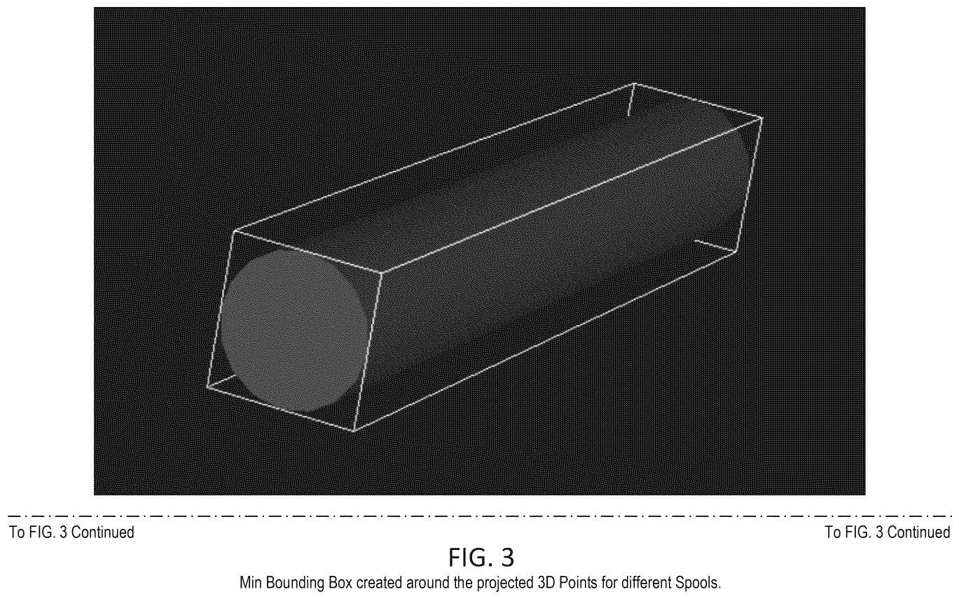

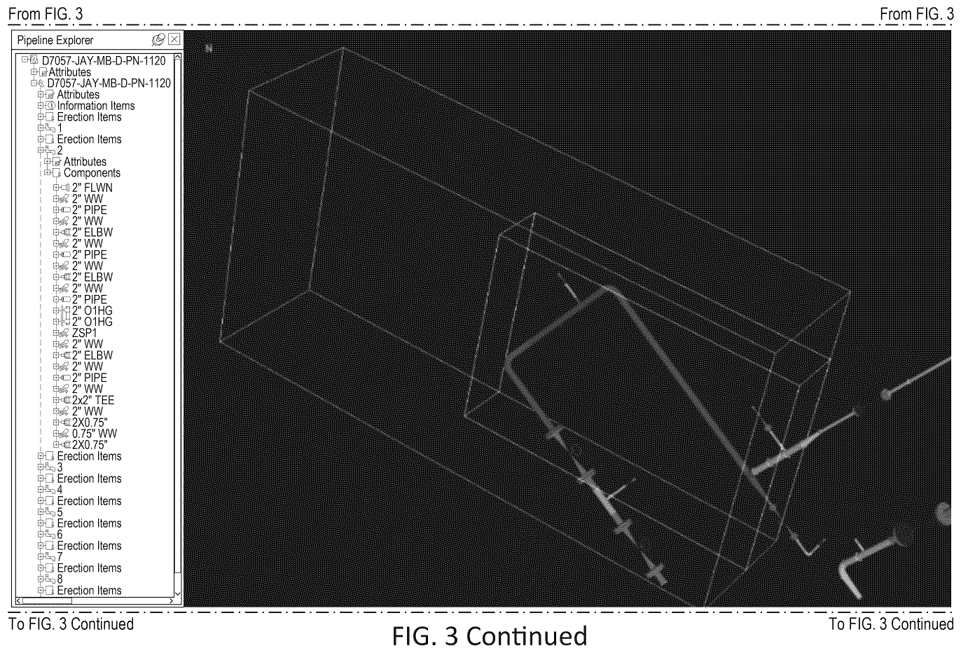

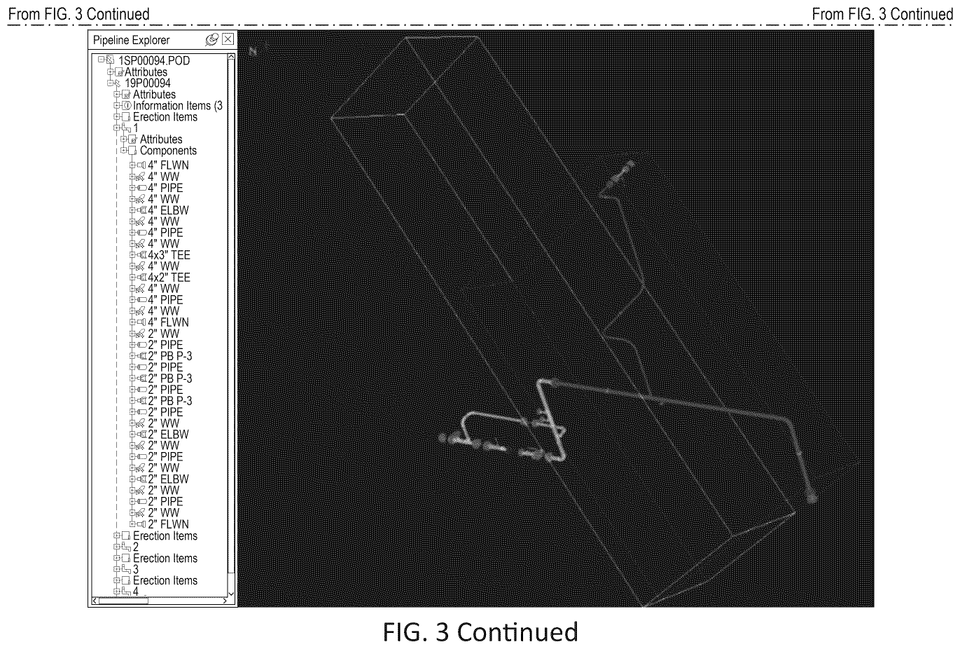

Exemplary embodiments will perform algebraic computations to evaluate the peripheral points from the center points of the piping components, fetched from either the PCF or the piping isometric model in SPOOLGEN, by projecting these points along the outer diameter of the respective components. This functionality can generate points that depict the range of the outer geometry of spool components in a two pronged approach by computing the peripheral points on the piping component's outer diameter (OD) projected along the perpendicular vectors normal to the leg direction (pipe route direction) and parallel to the plane on the pipe endpoints, i.e., along the normal (demonstrated in FIG. 4, which is a schematic diagram showing a pipe component center line and projected points on the plane passing through the center points and is discussed further below) representing the outer surface of the spool. This geometry information is further utilized to determine the pipe spool's volume in 3D space to further determine the container's size for transportation and pre-manufacturing checks. These capabilities ensure that designated spools can either seamlessly fit within assigned containers, or, in case of misfit, provide the versatility to divide spools and establish fresh bounding boxes for individual spool sections as demonstrated in FIG. 3, which includes screenshots showing representations of minimum bounding boxes created around projected 3D points for three example spools, in accordance with certain embodiments.

As demonstrated schematically in FIG. 4, the following is an overview of a process for computing the extents of pipes in accordance with certain embodiments (with all operations done in 3D space):
Get the 3D coordinates start (C₁) and end (C₂) key points of the pipe and the leg direction vector (L_{d}) in the spool using component attributes in a piping isometrics model (which typically contains center points of the piping components and outer diameter) or from PCF data.
Compute the normal vector (N₁) to leg direction vector at the endpoints of the pipe.
Project the center key point to the outer boundary of the pipe along the length of the outer radius.
Calculate both the vectors (+/−N₁, +/−N₂) normal to the leg direction and use these vectors for projecting the key points along the component OD (Outer Diameter).
Vectors +/−N₁, +/−N₂ represent the direction normal to the leg direction and will be lying on the plane of the center point.
Project each center key point (C_{1,2}) of the piping component along the radius of the pipe along the two normal vectors (+/−N₁, +/−N₂) in both directions which are represented as P¹, P², P³, P⁴
Points P¹, P², P³, P⁴ represent the peripheral points of the pipe outer geometry which cannot represent the complete range of the circular surface, therefore project these points along +/−N₁, +/−N₂ vectors along the length of the outer radius to enclose the pipe outer surface represented by R₁, R₂, R₃, R₄.
Points R1, R2, R3, R4 represent the range extents of the pipe surface encompassing the complete outer geometry of the pipe.
Repeat the above logic for all the components in the spool and create a list of all the points data and send it for volume computation.

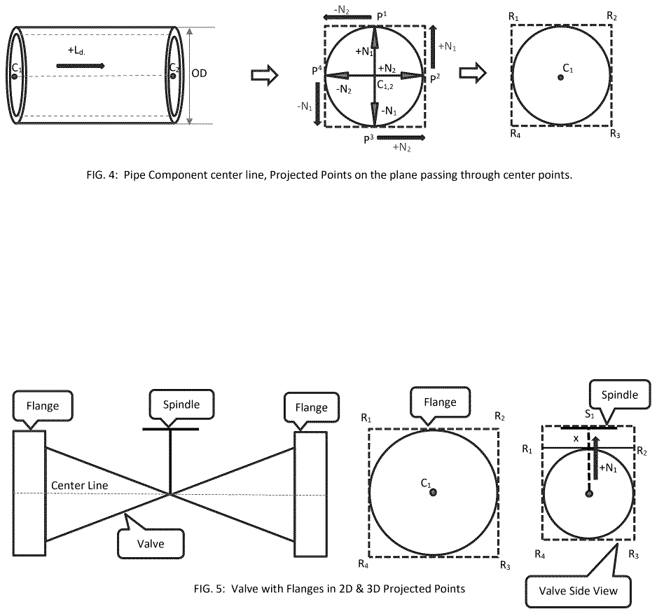

As demonstrated schematically in FIG. 5, the following is an overview of a process for computing the extents of other piping components like flanges and valves in accordance with certain embodiments (with all operations done in 3D space):
In the case of other piping components like flanges and valves, project the center key point of the respective component along the direction of two normal vectors (+/−N₁, +/−N₂) with a length equivalent to the radius of the flange OD (like a pipe) in both the directions along the outer boundary, which are represented as R₁, R₂, R₃, R₄.
In the case of the valve having a spindle connecting to the center point of the valve, to get the 3D point depicting the spindle endpoint, the cone center connect point is used to compute the 3D extents (S1) by projecting it on to the end of the spindle along the normal vector at a length equivalent to spindle leg length (x).

The following is a generic overview of the above processes:
Get the key points of the Components: Center key points of the component are identified using component attributes in a piping isometrics model or can be read from the PCF.
Get the leg direction of the Components: The leg direction of the components is obtained.
Get the coordinates of the Key points of the components: Loop through each key point and obtain the center coordinates of the component.
Calculate the Coordinates of the Outer diameter of the components: To calculate the outer diameter of the components, two perpendicular vectors are computed along the leg direction of the components, as follows:
   1. The unit perpendicular vector is calculated using the direction vector of the component.
   2. The normal vector is calculated by doing the cross product of the vector along the direction of the component and Unit perpendicular vector.

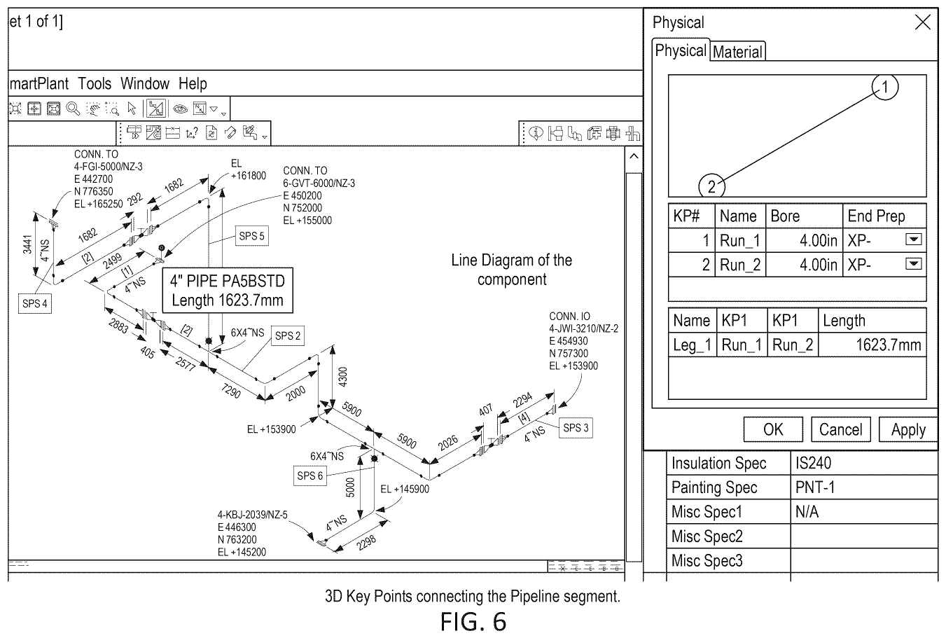

FIG. 6 is a portion of a screenshot showing 3D key points connecting a pipeline segment, in accordance with certain embodiments.

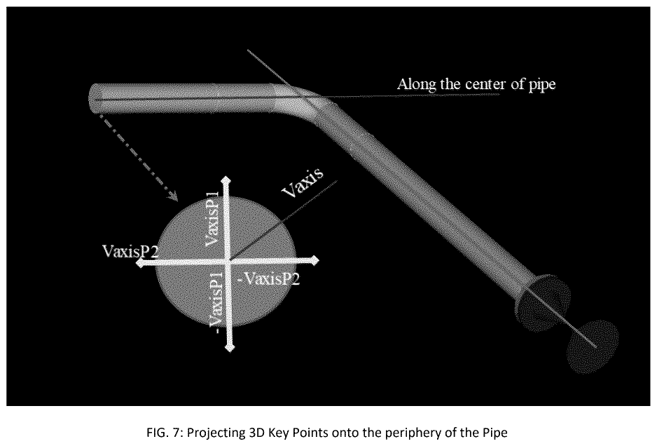

FIG. 7 is a schematic diagram providing an example of projecting 3D key points onto the periphery of a pipe, in accordance with certain embodiments. Here, the following vectors are defined:
Vaxis=Vector along the center of the pipe
VaxisP1=First Vector perpendicular to vector along the center of the pipe
VaxisP1=Opposite to the VaxisP1
VaxisP2=2^{nd} Vector perpendicular to VaxisP1 and Vaxis
VaxisP2=Opposite to VaxisP2

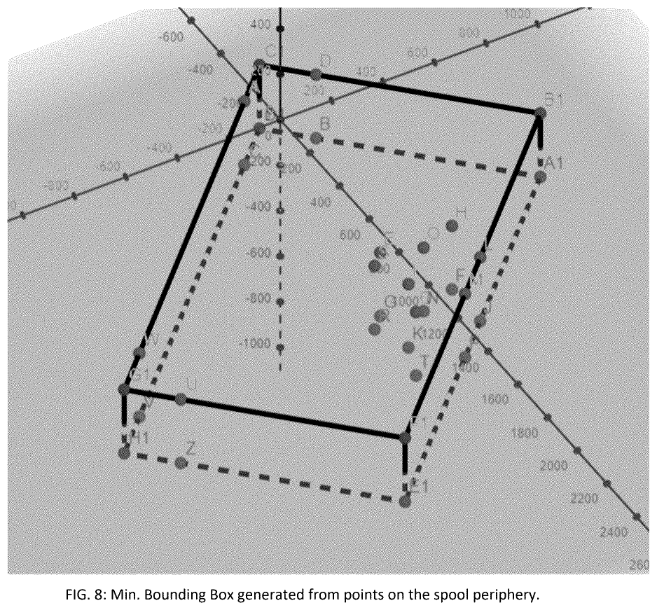

FIG. 8 is a schematic diagram providing an example of a minimum bounding box generated from points on a spool periphery, in accordance with certain embodiments. This figure was generated from an online open source tool that takes 3D points as input and visualizes them as per user requirements in 3D space, specifically by providing a set of peripheral 3D points that represent the outer geometry of the pipe spool that are plotted as solid spheres and also by providing the 3D Bounding box points that are obtained from the bounding box algorithm and plotted as lines in 3D.

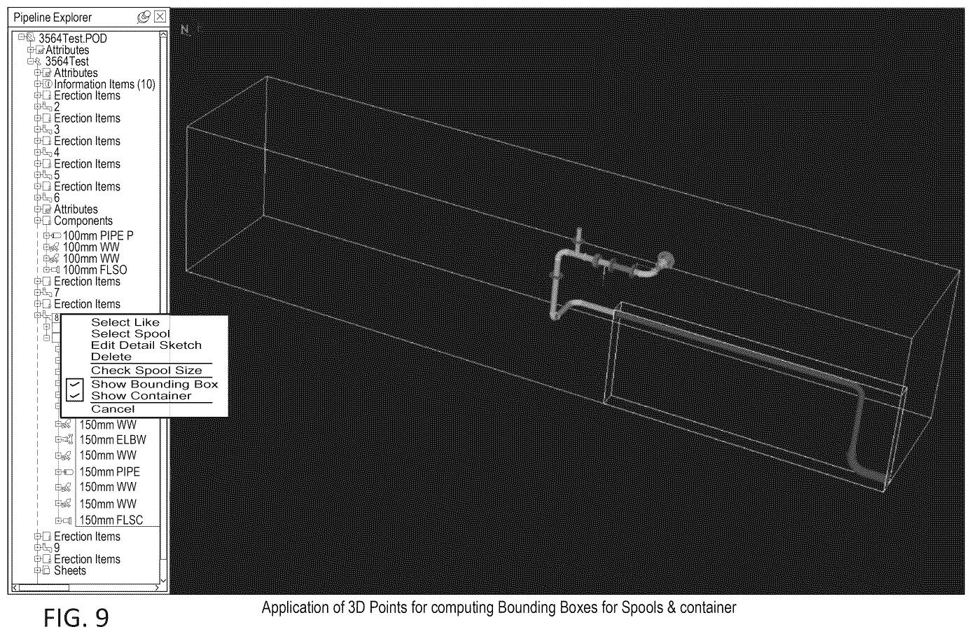

FIG. 9 is a screenshot showing an example graphical user interface for generating and displaying a bounding box and/or container using the 3D points computed as described herein, in accordance with certain embodiments. It should be noted that the box can be displayed differently for a pipe spool that will fit in a given container vs. a pipe spool that will not fit in the given container, e.g., using different line types (e.g., solid if fits vs. dashed if doesn't fit), different colors (e.g., red if doesn't fit vs. white or yellow if fits), or other characteristics.

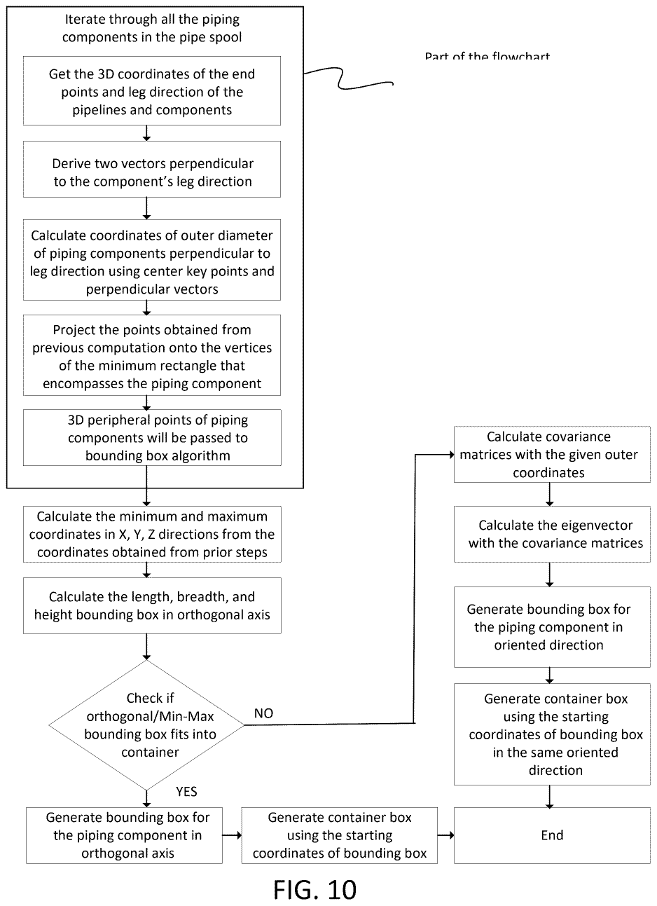

FIG. 10 is a flow chart depicting a process for computing points representing the outer periphery of a spool, in accordance with certain embodiments.

Here, the process iterates through all the piping components in the pipe spool to obtain the 3D coordinates of the end points and leg direction of the pipelines and components (e.g., by extracting the 3D coordinates from component attributes in a piping isometrics model or from PCF data), derive two vectors perpendicular to the component's leg direction, calculate the coordinates of outer diameter of the piping components perpendicular to the leg direction using the center key points and perpendicular vectors, project the points obtained from the previous computation onto the vertices of a minimum rectangle that encompasses the piping component; and pass the 3D peripheral points of the piping components to a bounding box computation process.

The bounding box computation process calculates the minimum and maximum coordinates in the X, Y, and Z directions from the coordinates obtained from the prior computations, computes the oriented axes (which in some cases may align with orthogonal axes), and calculates the length, breadth, width, and height bounding box with respect to the oriented axes to determine the tight bounding box/minimum bounding box.

A further process may check if the orthogonal/min-max bounding box fits into a given container. If so, then the process may generate a bounding box for the piping component in the orthogonal axis and/or generate a container box using the starting coordinates of the bounding box.

In some cases, insights gleaned from the described computations including the bounding box and container computations may be the impetus to redesign piping systems and pipe spools such as to reduce the size of a pipe spool in one or more dimensions or aspects (which, for example, could involve adding components such as additional connectors), e.g., so that the modified pipe spool will fit within a particular container even if the number of pipe spools for a piping system increases, or to increase the size of a pipe spool in one or more dimensions or aspects (which, for example, could involve removing components), e.g., to reduce the number of spool components for cost saving while also allowing the spool to fit within a particular container.

Insights gleaned from the described computations including the bounding box and container computations also can be used to train and/or retrain an artificial intelligence/machine learning engine as part of a piping management system (e.g., an AI/ML engine that assists with piping design, manufacture, testing, transportation, etc.). For example, AI/ML techniques can be leveraged to learn from the input spool components geometry and determine the minimum volume that is needed for a given spool. A linear regression model can be trained to learn from the ground truth by understanding patterns of connections between the components and to build a model that can be extrapolated to predict the approximate minimum volume that is required for given test spool data. This way, the transportation requirements for spools can be optimized. Also, 3D scanned point cloud data points can be processed using deep learning to determine the minimum volume and the container that it will fit in.

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In alternative embodiments, the disclosed apparatus and methods (e.g., as in any flow charts or logic flows described above) may be implemented as a computer program product for use with a computer system. Such implementation may include a series of computer instructions fixed on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as a tangible, non-transitory semiconductor, magnetic, optical or other memory device, and may be transmitted using any communications technology, such as optical, infrared, RF/microwave, or other transmission technologies over any appropriate medium, e.g., wired (e.g., wire, coaxial cable, fiber optic cable, etc.) or wireless (e.g., through air or space).

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads. Software systems may be implemented using various architectures such as a monolithic architecture or a microservices architecture.

It should be noted that terms such as server, computer, personal computing device, user equipment, laptop, tablet, mobile communication device, smartphone, etc. may be used herein to describe devices or systems that may be used in certain embodiments of the present invention and should not be construed to limit the present invention to any particular device or system type unless the context otherwise requires. As discussed herein, such devices or systems typically include one or more network interfaces for communicating over a communication network and at least one processor (e.g., a microprocessor with memory and other peripherals and/or application-specific hardware) configured accordingly to perform device or system functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth, WiFi, cellular, etc.), networking technologies, and internetworking technologies.

It should also be noted that devices and systems may use communication protocols and messages (e.g., messages created, transmitted, received, stored, and/or processed by the device or system), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message. Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. Computer program logic implementing some or all of the described functionality is typically implemented as a set of computer program instructions that is converted into a computer executable form, stored as such in a computer readable medium, and executed by one or more processors optionally under the control of an operating system. Hardware-based logic implementing some or all of the described functionality may be implemented using one or more appropriately configured FPGAs or other programmable logic devices.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

While the invention has been particularly shown and described with reference to specific embodiments, it will be understood by persons of ordinary skill in the art that various changes in form and detail may be made without departing from the spirit and scope of the invention as defined by the appended clauses. While some of these embodiments have been described in the claims by process steps, an apparatus comprising a computer capable of executing the process steps is also included in the present invention. Likewise, a computer program product comprising a tangible, non-transitory computer readable medium having embodied therein computer executable instructions for executing the process steps is included in the present invention. Data signals embodying computer program instructions and/or messages received or transmitted over a communication system are also included in the present invention. Unless the context requires otherwise, the various functions and features described herein can be used in combination even if disclosed or claimed individually. Thus, for example, it is contemplated that dependent claims included below could be rewritten into multiple dependent form to depend from the base claim and an intervening claim(s).

Importantly, it should be noted that embodiments of the present invention may employ conventional components such as conventional computers (e.g., off-the-shelf PCs, mainframes, microprocessors), conventional programmable logic devices (e.g., off-the shelf FPGAs or PLDs), or conventional hardware components (e.g., off-the-shelf ASICs or discrete hardware components) which, when programmed or configured to perform the non-conventional methods described herein, produce non-conventional devices or systems. Thus, there is nothing conventional about the inventions described herein because even when embodiments are implemented using conventional components, the resulting devices and systems are necessarily non-conventional because, absent special programming or configuration, the conventional components do not inherently perform the described non-conventional functions.

The activities described and claimed herein provide technological solutions to problems that arise squarely in the realm of technology. These solutions as a whole are not well-understood, routine, or conventional and in any case provide practical applications that transform and improve computers and computer routing systems.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It should be noted that connecting lines with or without arrows may be used in drawings to represent communication, transfer, or other activity involving two or more entities. Connecting lines with double-ended arrows generally indicate that activity may occur in both directions (e.g., a command/request in one direction with a corresponding reply back in the other direction, or peer-to-peer communications initiated by either entity), although in some situations, activity may not necessarily occur in both directions. Connecting lines with single-ended arrows generally indicate activity exclusively or predominantly in the direction of the arrow, although it should be noted that, in certain situations, such directional activity may involve activities in the opposite direction or in both directions (e.g., a message from a sender to a receiver and an acknowledgment back from the receiver to the sender, or establishment of a connection prior to a transfer and termination of the connection following the transfer). Thus, the type of arrow used in a particular drawing to represent a particular activity is exemplary and should not be seen as limiting. Connecting lines with no arrows can indicate activity in one, the other, or both directions as the context suggests. Dashed connecting lines may be used to represent optional or ancillary activities as the context suggests.

Although the above discussion discloses various exemplary embodiments of the invention, it should be apparent that those skilled in the art can make various modifications that will achieve some of the advantages of the invention without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A system comprising:
at least one processor and at least one tangible, non-transitory computer readable medium having embodied therein computer program instructions for computing peripheral points of pipe spool components, which, when executed by the at least one processor, perform computer processes comprising, for each of a plurality of piping components of a pipe spool:
extracting 3D end point coordinates and leg direction of the pipeline component from component attributes in a piping isometrics model or PCF data;
deriving two vectors perpendicular to the component's leg direction;
computing coordinates of an outer diameter of the piping component perpendicular to the leg direction using center key points and the perpendicular vectors;
projecting the coordinates onto vertices of a minimum rectangle that encompasses the piping component;
computing minimum and maximum coordinates in X, Y, and Z directions from the computed coordinates for the plurality of pipeline components; and
computing a minimum bounding box for the pipe spool based on the minimum and maximum coordinates in the X, Y, and Z directions.

2. The system of claim 1, wherein the bounding box is computed without generating 3D surface models of the plurality of piping components.

3. The system of claim 1, wherein computing the bounding box comprises computing oriented axes for the bounding box based on the minimum and maximum coordinates in the X, Y, and Z directions and computing the length, width, and height of the bounding box with respect to the oriented axes.

4. The system of claim 1, wherein projecting the coordinates comprises computing the following vectors:
Vaxis=Vector along the center of the pipe;
VaxisP1=First Vector perpendicular to vector along the center of the pipe;
−VaxisP1=Opposite to the VaxisP1;
VaxisP2=2^{nd} Vector perpendicular to VaxisP1 and Vaxis; and
−VaxisP2=Opposite to VaxisP2.

5. The system of claim 1, wherein the plurality of pipeline components includes at least one component having an irregular shape and wherein computing coordinates of an outer diameter of the piping component comprises converting the irregular shape to unique points in 3D space.

6. The system of claim 1, further comprising:
displaying the bounding box on a computer display for analysis by a user.

7. The system of claim 1, further comprising:
determining if the bounding box fits within a predetermined container.

8. A computer program product comprising at least one tangible non-transitory computer readable medium having embodied therein computer program instructions for computing peripheral points of pipe spool components, which, when executed by at least one processor, cause the at least one processor to perform computer processes comprising:
extracting 3D end point coordinates and leg direction of the pipeline component from component attributes in a piping isometrics model or PCF data;
deriving two vectors perpendicular to the component's leg direction;
computing coordinates of an outer diameter of the piping component perpendicular to the leg direction using center key points and the perpendicular vectors;
projecting the coordinates onto vertices of a minimum rectangle that encompasses the piping component;
computing minimum and maximum coordinates in X, Y, and Z directions from the computed coordinates for the plurality of pipeline components; and
computing a minimum bounding box for the pipe spool based on the minimum and maximum coordinates in the X, Y, and Z directions.

9. The computer program product of claim 8, wherein the bounding box is computed without generating 3D surface models of the plurality of piping components.

10. The computer program product of claim 8, wherein computing the bounding box comprises computing oriented axes for the bounding box based on the minimum and maximum coordinates in the X, Y, and Z directions and computing the length, width, and height of the bounding box with respect to the oriented axes.

11. The computer program product of claim 8, wherein projecting the coordinates comprises computing the following vectors:
Vaxis=Vector along the center of the pipe;
VaxisP1=First Vector perpendicular to vector along the center of the pipe;
−VaxisP1=Opposite to the VaxisP1;
VaxisP2=2^{nd} Vector perpendicular to VaxisP1 and Vaxis; and
−VaxisP2=Opposite to VaxisP2.

12. The computer program product of claim 8, wherein the plurality of pipeline components includes at least one component having an irregular shape and wherein computing coordinates of an outer diameter of the piping component comprises converting the irregular shape to unique points in 3D space.

13. The computer program product of claim 8, further comprising:
displaying the bounding box on a computer display for analysis by a user.

14. The computer program product of claim 8, further comprising:
determining if the bounding box fits within a predetermined container.

15. A computer-implemented method for computing peripheral points of pipe spool components, the method comprising:
extracting 3D end point coordinates and leg direction of the pipeline component from component attributes in a piping isometrics model or PCF data;
deriving two vectors perpendicular to the component's leg direction;
computing coordinates of an outer diameter of the piping component perpendicular to the leg direction using center key points and the perpendicular vectors;
projecting the coordinates onto vertices of a minimum rectangle that encompasses the piping component;
computing minimum and maximum coordinates in X, Y, and Z directions from the computed coordinates for the plurality of pipeline components; and
computing a minimum bounding box for the pipe spool based on the minimum and maximum coordinates in the X, Y, and Z directions.

16. The method of claim 15, wherein the bounding box is computed without generating 3D surface models of the plurality of piping components.

17. The method of claim 15, wherein computing the bounding box comprises computing oriented axes for the bounding box based on the minimum and maximum coordinates in the X, Y, and Z directions and computing the length, width, and height of the bounding box with respect to the oriented axes.

18. The method of claim 15, wherein projecting the coordinates comprises computing the following vectors:
Vaxis=Vector along the center of the pipe;
VaxisP1=First Vector perpendicular to vector along the center of the pipe;
−VaxisP1=Opposite to the VaxisP1;
VaxisP2=2^{nd} Vector perpendicular to VaxisP1 and Vaxis; and
−VaxisP2=Opposite to VaxisP2.

19. The method of claim 15, wherein the plurality of pipeline components includes at least one component having an irregular shape and wherein computing coordinates of an outer diameter of the piping component comprises converting the irregular shape to unique points in 3D space.

20. The method of claim 15, further comprising:
displaying the bounding box on a computer display for analysis by a user.

21. The method of claim 15, further comprising:
determining if the bounding box fits within a predetermined container.
